(19) United States
(12) Patent Application Publication
(10) Pub. No.: US 2024/0235877 A1
(43) Pub. Date: Jul. 11, 2024

(54) INFORMATION CONTROL METHOD AND APPARATUS, NETWORK FUNCTION, AND READABLE STORAGE MEDIUM

(71) Applicant: VIVO MOBILE COMMUNICATION CO., LTD., Guangdong (CN)

(72) Inventors: Zhenhua XIE, Guangdong (CN); Wen WANG, Guangdong (CN)

(73) Assignee: VIVO MOBILE COMMUNICATION CO., LTD., Guangdong (CN)

(21) Appl. No.: 18/613,921

(22) Filed: Mar. 22, 2024

Related U.S. Application Data
(63) Continuation of application No. PCT/CN2022/120534, filed on Sep. 22, 2022.

(30) Foreign Application Priority Data
Sep. 28, 2021 (CN) 202111143205.1

(51) Int. Cl. H04L 12/18; H04L 67/146

(52) U.S. Cl. CPC H04L 12/189; H04L 67/146

(57) ABSTRACT

An information control method and apparatus, a network function device, a chip, a computer program product, and a readable storage medium. The information control method of the embodiments of this application includes: sending, by a radio access network (RAN) node, interaction assistance information to a first core network function, where the interaction assistance information is used to assist the first core network function in invoking information related to multicast and broadcast service management or session management to a second core network function, or the interaction assistance information is used to assist the first core network function in rejecting to invoke information related to the multicast and broadcast service management or session management to the second core network function.

### CROSS-REFERENCE TO RELATED APPLICATIONS

This application is a continuation of International Application No. PCT/CN2022/120534 filed on Sep. 22, 2022, which claims priority to Chinese Patent Application No. 202111143205.1 filed on Sep. 28, 2021, which are incorporated herein by reference in their entireties.

### TECHNICAL FIELD

This application pertains to the field of communications technologies, and in particular, to an information control method and apparatus, a network function, and a readable storage medium.

### BACKGROUND

When a communications network is used to provide a multicast service, a shared tunnel is usually established between a radio access network (RAN) node and a core network (CN) node to transmit a piece of data, and then the RAN node sends the received piece of data to a plurality of terminals. In the process of establishing and/or releasing the existing shared tunnel, an access management function (AMF) is required to invoke a service operation of a multicast and broadcast session management function (MB-SMF), which leads to complicated interaction operations between different core network functions.

### SUMMARY

According to a first aspect, an information control method is provided, including: sending, by a RAN node, interaction assistance information to a first core network function, where

the interaction assistance information is used to assist the first core network function in invoking information related to multicast and broadcast service management or session management to a second core network function, or the interaction assistance information is used to assist the first core network function in rejecting to invoke information related to the multicast and broadcast service management or session management to the second core network function.

According to a second aspect, an information control method is provided, including:

receiving, by a first core network function, interaction assistance information from a RAN node; and

invoking, by the first core network function based on the interaction assistance information, information related to multicast and broadcast service management or session management to a second core network function, or rejecting to invoke information related to the multicast and broadcast service management or session management to the second core network function.

According to a third aspect, an information control apparatus is provided, including:

a sending module, configured to send interaction assistance information to a first core network function, where

the interaction assistance information is used to assist the first core network function in invoking information related to multicast and broadcast service management or session management to a second core network function, or the interaction assistance information is used to assist the first core network function in rejecting to invoke information related to the multicast and broadcast service management or session management to the second core network function.

According to a fourth aspect, an information control apparatus is provided, including:

a receiving module, configured to receive interaction assistance information from a RAN node; and

a processing module, configured to: invoke, based on the interaction assistance information, information related to multicast and broadcast service management or session management to a second core network function, or reject to invoke information related to the multicast and broadcast service management or session management to the second core network function.

According to a fifth aspect, a network function is provided. The network function includes a processor, a memory, and a program or an instruction stored in the memory and executable on the processor, where the program or the instruction is executed by the processor to implement steps of the method according to the first aspect or steps of the method according to the second aspect.

According to a sixth aspect, a network function is provided, including a processor and a communications interface, where when the network function is a RAN node, the communications interface is configured to send interaction assistance information to a first core network function, the interaction assistance information is used to assist the first core network function in invoking information related to multicast and broadcast service management or session management to a second core network function, or the interaction assistance information is used to assist the first core network function in rejecting to invoke information related to the multicast and broadcast service management or session management to the second core network function; or when the network function is a first core network function, the communications interface is configured to receive interaction assistance information from a RAN node, the processor is configured to: invoke, based on the interaction assistance information, information related to multicast and broadcast service management or session management to a second core network function, or reject to invoke information related to the multicast and broadcast service management or session management to the second core network function.

According to a seventh aspect, a readable storage medium is provided, where the readable storage medium stores a program or an instruction, and when the program or the instruction is executed by a processor, steps of the method according to the first aspect or the second aspect are implemented.

According to an eighth aspect, a chip is provided. The chip includes a processor and a communications interface, the communications interface is coupled to the processor, and the processor is configured to run a program or an instruction, to implement steps of the method according to the first aspect or the second aspect.

According to a ninth aspect, a computer program product is provided. The computer program product is stored in a non-transient storage medium, and the computer program product is executed by at least one processor to implement steps of the method according to the first aspect or steps of the method according to the second aspect.

According to a tenth aspect, a communications device is provided, where the communications device is configured to perform the method according to the first aspect or the second aspect.

### BRIEF DESCRIPTION OF DRAWINGS

FIG. 1 is a block diagram of a wireless communications system to which embodiments of this application are applicable;

FIG. 2 is a schematic diagram of a unicast transmission manner of a shared tunnel according to an embodiment of this application;

FIG. 3 is a schematic diagram of a multicast transmission manner of a shared tunnel according to an embodiment of this application;

FIG. 4 is a schematic flowchart of an information control method according to an embodiment of this application;

FIG. 5 is a schematic flowchart of another information control method according to an embodiment of this application;

FIG. 6 is a schematic diagram of a structure of an information control apparatus according to an embodiment of this application;

FIG. 7 is a schematic diagram of a structure of another information control apparatus according to an embodiment of this application; and

FIG. 8 is a schematic diagram of a structure of a network function according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that, the technologies described in the embodiments of this application are not limited to a Long Term Evolution (LTE)/LTE-Advanced (LTE-A) system, and can also be used in other wireless communications systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. The following descriptions describe a new radio (NR) system for example purposes, and NR terms are used in most of the following descriptions, but these technologies can also be applied to an application other than an NR system application, for example, a 6^{th} generation (6G) communications system.

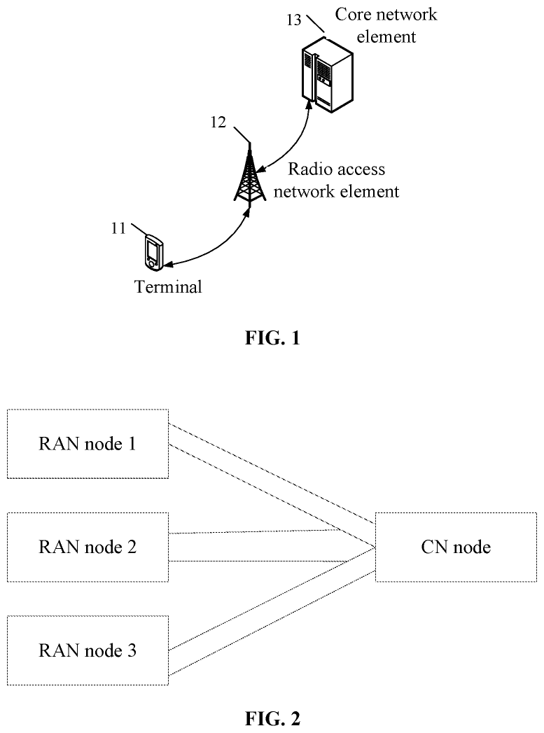

FIG. 1 is a block diagram of a wireless communications system to which the embodiments of this application can be applied. The wireless communications system includes a terminal 11, a wireless access network element 12, and a core network element 13. The terminal 11 may also be referred to as a terminal device or user equipment (UE). The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), and smart household (household devices with wireless communications functions, such as a refrigerator, a television, a washing machine, or furniture). The wearable device includes a smart watch, a smart band, smart earphones, smart glasses, smart jewelry (a smart bracelet, a smart hand chain, a smart ring, a smart necklace, a smart bangle, a smart anklet, or the like), a smart wristband, smart clothes, a game console, and the like. It should be noted that a specific type of the terminal 11 is not limited in the embodiments of this application.

The radio access network element 12 can be referred to as at least one of the following: a RAN device, a RAN node, a radio access network function, and a radio access network unit; and the radio access network element may include, but is not limited to, at least one of the following: a RAN device, a RAN node, a RAN function, a RAN unit, a third generation partnership project (3GPP) radio access network, a non-3GPP radio access network, a centralized unit (CU), a distributed unit (DU), a base station, an evolved NodeB (eNB), a 5G base station (gNB), a radio network controller (RNC), a NodeB, a non-3GPP inter working function (N3IWF), an access control (AC) node, an access point (AP) device, and a wireless local area network (WLAN) node.

The core network element 13 can be referred to as at least one of the following: a core network device, a core network node, a core network function, and a core network unit. The core network element may include but is not limited to at least one of the following: a mobility management entity (MME), an access management function (AMF), a session management function (SMF), a user plane function (UPF), a multicast and broadcast session management function (MB-SMF), a multicast and broadcast user plane function (MB-UPF), a serving GW (SGW), a packet data network (PDN) gateway (PDN gateway), a policy control function (PCF), a policy and charging rules function (PCRF) unit, a general packet radio service (GPRS) serving GPRS support node (SGSN), a gateway GPRS support node (GGSN), unified data management (UDM), unified data repository (UDR), a home subscriber server (HSS), an application function (AF), and a centralized network configuration (CNC).

In order to better understand embodiments of this application, the following content is first described.

When a communications network, such as a 5G network, is used to provide a multicast service, a shared tunnel is established between a RAN node and a CN node to transmit a piece of data, and then the RAN node sends the received piece of data to a plurality of terminals. The shared tunnel is only used to send downlink data rather than uplink data, so it only needs to negotiate shared tunnel information between the RAN node and the CN node, such as downlink (DL) tunnel information, including a transmission address and a tunnel identifier.

Optionally, as shown in FIG. 2, the CN node can distribute data to each RAN node through a shared tunnel with each RAN node (for example, three RAN nodes in FIG. 2, but it is not limited to this). Such a shared tunnel uses a unicast transmission manner, and a transmission address in the shared tunnel information is a unicast address.

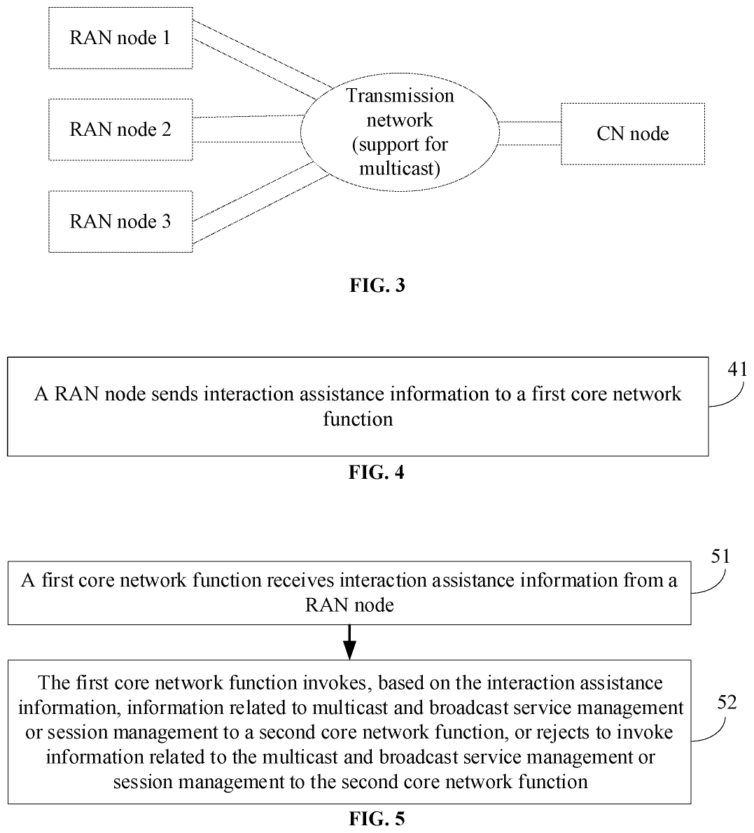

Optionally, as shown in FIG. 3, the CN node can send data to a plurality of RAN nodes (for example, three RAN nodes in FIG. 3, but it is not limited to this) through one shared tunnel in a multicast transmission manner, that is, the plurality of RAN nodes join one multicast group, the CN node sends a piece of data to the multicast group through the shared tunnel, the transmission network distributes this piece of data to the plurality of RAN nodes in the multicast group, and the transmission address in the shared tunnel information is the multicast address.

At present, when a shared tunnel is established, the RAN node needs to negotiate the shared tunnel information through the AMF and the MB-SMF, such as DL tunnel information. If the shared tunnel uses a unicast transmission manner, the RAN node needs to provide the shared tunnel information for the MB-SMF, so that the CN node can establish a shared tunnel with each RAN node. However, if the shared tunnel uses a multicast transmission manner, the RAN node needs to obtain the shared tunnel information from the MB-SMF, so as to join the corresponding multicast group and receive corresponding shared tunnel data from the multicast group. In this case, when the shared tunnel uses the multicast transmission manner, because the shared tunnel information may be stored in the RAN node, it is not required to obtain the shared tunnel information from the MB-SMF, that is, when the shared tunnel is established, it is not required to negotiate the shared tunnel information between the AMF and the MB-SMF, and a signaling interaction process between the AMF and the MB-SMF is not required. Therefore, the signaling interaction process between different core network functions in the existing shared tunnel establishment process can be optimized.

To optimize the interaction operations between different core network functions, the embodiments of this application propose that the RAN node sends interaction assistance information to the first core network function, where the interaction assistance information is used to assist the first core network function in invoking information related to multicast and broadcast service management or session management to a second core network function, or assist the first core network function in rejecting to invoke information related to the multicast and broadcast service management or session management to the second core network function. Therefore, with the interaction assistance information sent by the RAN node, the first core network function can invoke or reject to invoke information related to a multicast and broadcast service management or session management to a second core network function, thereby reducing the unnecessary signaling interaction process between the first core network function and the second core network function, and optimizing the interaction operation between different core network functions.

The following describes in detail the information control method and apparatus, the network function, and the readable storage medium provided in the embodiments of this application through some embodiments and application scenarios thereof with reference to the accompanying drawings.

It should be noted that the network function in this application can also be referred to as a network element or an NE.

Referring to FIG. 4, FIG. 4 is a flowchart of an information control method according to an embodiment of this application. The method is performed by a RAN node. As shown in FIG. 4, the method includes the following steps.

Step 41: A RAN node sends interaction assistance information to a first core network function.

In this embodiment, the interaction assistance information is used to assist the first core network function in invoking information related to multicast and broadcast service management or session management to a second core network function, or the interaction assistance information is used to assist the first core network function in rejecting to invoke information related to the multicast and broadcast service management or session management to the second core network function. That is, the interaction assistance information is used to assist the first core network function in invoking or rejecting in invoking the service operation of the second core network function.

In some embodiments, the interaction assistance information is used to assist the first core network function in invoking information related to multicast and broadcast service management to a second core network function.

In some embodiments, the interaction assistance information is used to assist the first core network function in invoking information related to multicast and broadcast session management to a second core network function.

In some embodiments, the interaction assistance information is used to assist the first core network function in rejecting to invoke information related to multicast and broadcast service management to a second core network function.

In some embodiments, the interaction assistance information is used to assist the first core network function in rejecting to invoke information related to multicast and broadcast session management to a second core network function.

In some embodiments, optionally, the first core network function can be the AMF, and correspondingly, the second core network function is the MB-SMF.

According to the information control method in this embodiment of this application, the RAN node can send interaction assistance information to the first core network function, where the interaction assistance information is used to assist the first core network function in invoking information related to multicast and broadcast service management or session management to a second core network function, or assist the first core network function in rejecting to invoke information related to the multicast and broadcast service management or session management to the second core network function. Therefore, with the interaction assistance information sent by the RAN node, the first core network function can invoke or reject to invoke information related to a multicast and broadcast service management or session management to a second core network function, thereby reducing the unnecessary signaling interaction process between the first core network function and the second core network function, and optimizing the interaction operation between different core network functions.

In this embodiment of this application, the RAN node can send the interaction assistance information to the first core network function in the process of establishing or releasing the shared tunnel. Optionally, the RAN node may send the interaction assistance information to the first core network function through any one of following:

a shared tunnel establishment request, and a shared tunnel release request.

In some embodiments, the RAN node may carry the interaction assistance information in a shared tunnel establishment request sent to the AMF, to assist the AMF in determining whether it is required to invoke information to the MB-SMF, thereby reducing the shared tunnel establishment request/response between the AMF and the MB-SMF when it is determined that it is not required to interact with the MB-SMF, thereby reducing the unnecessary signaling interaction process between the AMF and the MB-SMF, and optimizing the interaction operation between the AMF and the MB-SMF.

In other embodiments, the RAN node may carry the interaction assistance information in a shared tunnel release request sent to the AMF, to assist the AMF in determining whether it is required to invoke information to the MB-SMF, thereby reducing the shared tunnel release request/response between the AMF and the MB-SMF when it is determined that it is not required to interact with the MB-SMF, thereby reducing the unnecessary signaling interaction process between the AMF and the MB-SMF, and optimizing the interaction operation between the AMF and the MB-SMF.

Optionally, the interaction assistance information can meet at least one of following:

including information that is required to be sent to the second core network function, for example, including N2 session management (SM) information, location information, and the like that are required to be sent to the second core network function;

the information that is required to be sent to the second core network function is absent, for example, N2 SM information, location information, and the like that are required to be sent to the second core network function are absent;

including first indication information, where the first indication information is used to indicate that it is required to interact with the second core network function; or the first indication information is used to indicate that it is optional or not interacting with the second core network function, or to indicate that it is conditional or not interacting with the second core network function;

including transmission type indication information, where the transmission type indication information is used to indicate at least one of following: a transmission type is unicast, and the transmission type is multicast;

including first shared tunnel information; and

first shared tunnel information is absent.

Further, the interaction assistance information can meet at least one of following:

in a case that the interaction assistance information includes information that is required to be sent to the second core network function, the interaction assistance information is used to indicate that the first core network function is required to interact with the second core network function;

in a case that the interaction assistance information does not include the information that is required to be sent to the second core network function, the interaction assistance information is used to indicate any one of following: the first core network function optionally interacts with or does not interact with the second core network function, and the first core network function conditionally interacts with or does not interact with the second core network function;

in a case that the transmission type indication information included in the interaction assistance information indicates that the transmission type is unicast, the interaction assistance information is used to indicate that the first core network function is required to interact with the second core network function; and

in a case that the transmission type indication information included in the interaction assistance information indicates that the transmission type is multicast, the interaction assistance information is used to indicate any one of following: the first core network function optionally interacts with or does not interact with the second core network function, and the first core network function conditionally interacts with or does not interact with the second core network function.

Optionally, in a case that the interaction assistance information includes the first shared tunnel information, the interaction assistance information is used to indicate that the first core network function is required to interact with the second core network function.

Optionally, in a case that the interaction assistance information does not include the first shared tunnel information, the interaction assistance information is used to indicate any one of following: the first core network function optionally interacts with or does not interact with the second core network function, and the first core network function conditionally interacts with or does not interact with the second core network function.

Optionally, the first shared tunnel information may include at least one of following:

a transmission address and a tunnel identifier.

Optionally, when the interaction assistance information includes the first shared tunnel information, the interaction assistance information may meet at least one of following:

in a case that the first shared tunnel information includes a transmission address, and the transmission address is a multicast address, the interaction assistance information is used to indicate any one of following: the first core network function optionally interacts with or does not interact with the second core network function, and the first core network function conditionally interacts with or does not interact with the second core network function;

in a case that the first shared tunnel information includes a transmission address, and the transmission address is a unicast address or not a multicast address, the interaction assistance information is used to indicate that the first core network function is required to interact with the second core network function;

in a case that the first shared tunnel information includes a tunnel identifier, the interaction assistance information is used to indicate that the first core network function is required to interact with the second core network function; and

in a case that the first shared tunnel information does not include the tunnel identifier, the interaction assistance information is used to indicate any one of following: the first core network function optionally interacts with or does not interact with the second core network function, and the first core network function conditionally interacts with or does not interact with the second core network function.

Optionally, the first shared tunnel information may further include at least one of following:

a multicast and broadcast service (MBS) session identifier, which is used to indicate a multicast and broadcast session to which the shared tunnel belongs, where when the first core network function does not need to interact with the second core network function, although the RAN node needs to send the MBS session identifier to the first core network function, it can indicate not to send this information to the second core network function;

MBS quality of service (QoS) flow information, which is used to indicate information or an identifier serving the multicast and broadcast service (MBS) QoS flow, for example, when the MBS QoS flow changes, the second core network function needs to be notified;

MBS service area information, which is used to indicate a multicast and broadcast service area; and

an MBS area session identifier, which is used to uniquely identify one MBS session together with the MBS session identifier in some scenarios.

In this embodiment of this application, the RAN node may send the interaction assistance information to the first core network function based on the second shared tunnel information, to assist the first core network function in determining whether it is required to invoke information to the second core network function. The second shared tunnel information may include at least one of following: a transmission address and a tunnel identifier.

Optionally, when a first condition is met, the interaction assistance information is used to indicate any one of following: the first core network function optionally interacts with or does not interact with the second core network function, and the first core network function conditionally interacts with or does not interact with the second core network function. The first condition includes at least one of following: the second shared tunnel information includes a tunnel identifier; and the second shared tunnel information includes a transmission address, and the transmission address is a multicast address.

Optionally, when a second condition is met, the interaction assistance information is used to indicate that the first core network function is required to interact with the second core network function. The second condition includes at least one of following: the second shared tunnel information is unknown; and the second shared tunnel information includes a transmission address, and the transmission address is a unicast address or not a multicast address.

In some embodiments, in a case that the RAN node sends the interaction assistance information to the first core network function through the shared tunnel establishment request, when the second shared tunnel information includes a tunnel identifier, the interaction assistance information is used to indicate any one of following: the first core network function optionally interacts with or does not interact with the second core network function, and the first core network function conditionally interacts with or does not interact with the second core network function.

In some embodiments, in a case that the RAN node sends the interaction assistance information to the first core network function through the shared tunnel establishment request, when the second shared tunnel information is unknown, the interaction assistance information is used to indicate that the first core network function is required to interact with the second core network function.

In some embodiments, in a case that the RAN node sends the interaction assistance information to the first core network function through the shared tunnel release request, when the second shared tunnel information includes a transmission address, and the transmission address is a multicast address, the interaction assistance information is used to indicate any one of following: the first core network function optionally interacts with or does not interact with the second core network function, and the first core network function conditionally interacts with or does not interact with the second core network function.

In some embodiments, in a case that the RAN node sends the interaction assistance information to the first core network function through the shared tunnel release request, when the second shared tunnel information includes a transmission address, and the transmission address is a unicast address, the interaction assistance information is used to indicate that the first core network function is required to interact with the second core network function.

In some embodiments, the RAN node can obtain the shared tunnel information from the core network function such as the AMF, the SMF, and/or the MB-SMF before sending the interaction assistance information to the AMF based on the shared tunnel information. For example, when the shared tunnel is established, the core network function sends the shared tunnel information to the RAN node; or when the shared tunnel is released, the RAN node learns of the shared tunnel information locally.

Referring to FIG. 5, FIG. 5 is a flowchart of another information control method according to an embodiment of this application. The method is performed by a first core network function such as an AFM. As shown in FIG. 5, the method includes the following steps.

Step 51: A first core network function receives interaction assistance information from a RAN node.

In this embodiment, the interaction assistance information is used to assist the first core network function in invoking information related to multicast and broadcast service management or session management to a second core network function, or the interaction assistance information is used to assist the first core network function in rejecting to invoke information related to the multicast and broadcast service management or session management to the second core network function. That is, the interaction assistance information is used to assist the first core network function in invoking or rejecting in invoking the service operation of the second core network function.

Step 52: The first core network function invokes, based on the interaction assistance information, information related to multicast and broadcast service management or session management to a second core network function, or rejects to invoke information related to the multicast and broadcast service management or session management to the second core network function.

In some embodiments, optionally, the first core network function can be the AMF, and correspondingly, the second core network function is the MB-SMF.

For example, after receiving the interaction assistance information, the first core network function can send information related to multicast and broadcast service management or session management to the second core network function based on the interaction assistance information, or reject to send the information related to multicast and broadcast service management or session management to the second core network function.

It should be noted that the first core network function invokes information to the second core network function can be understood as that the first core network function invokes a service operation of the second core network function. That the first core network function rejects to invoke information to the second core network function can be understood as that the first core network function rejects to invoke the service operation of the second core network function.

In some embodiments, when the interaction assistance information indicates that it is required to interact with the second core network function, the first core network function invokes information related to multicast and broadcast service management or session management to the second core network function, namely, invoking the service operation of the second core network function.

In some embodiments, when the interaction assistance information indicates that it is optional (or conditional) or not interacting with the second core network function, the first core network function invokes information related to multicast and broadcast service management or session management to the second core network function, namely, invoking the service operation of the second core network function.

In some embodiments, when the interaction assistance information indicates that it is optional (or conditional) or not interacting with the second core network function, the first core network function rejects to invoke information related to multicast and broadcast service management or session management to the second core network function, namely, rejecting to invoke the service operation of the second core network function.

According to the information control method in this embodiment of this application, the first core network function can receive the interaction assistance information from the RAN node, and invokes or rejects to invoke, based on the received interaction assistance information, information related to multicast and broadcast service management or session management to the second core network function. Therefore, the unnecessary signaling interaction process between the first core network function and the second core network function can be reduced, and the interaction operation between different core network functions can be optimized.

In this embodiment of this application, the RAN node can send the interaction assistance information to the first core network function in the process of establishing or releasing the shared tunnel. Optionally, the first core network function can receive the interaction assistance information from the RAN node through any one of following:

a shared tunnel establishment request, and a shared tunnel release request.

In some embodiments, the RAN node may carry the interaction assistance information in a shared tunnel establishment request sent to the AMF, to assist the AMF in determining whether it is required to invoke information to the MB-SMF, thereby reducing the shared tunnel establishment request/response between the AMF and the MB-SMF when it is determined that it is not required to interact with the MB-SMF, thereby reducing the unnecessary signaling interaction process between the AMF and the MB-SMF, and optimizing the interaction operation between the AMF and the MB-SMF.

In other embodiments, the RAN node may carry the interaction assistance information in a shared tunnel release request sent to the AMF, to assist the AMF in determining whether it is required to invoke information to the MB-SMF, thereby reducing the shared tunnel release request/response between the AMF and the MB-SMF when it is determined that it is not required to interact with the MB-SMF, thereby reducing the unnecessary signaling interaction process between the AMF and the MB-SMF, and optimizing the interaction operation between the AMF and the MB-SMF.

Optionally, the interaction assistance information can meet at least one of following:

including the information that is required to be sent to the second core network function, for example, including N2 SM information, location information, and the like that are required to be sent to the second core network function;

the information that is required to be sent to the second core network function is absent, for example, N2 SM information, location information, and the like that are required to be sent to the second core network function are absent;

including first indication information, where the first indication information is used to indicate that it is required to interact with the second core network function; or the first indication information is used to indicate that it is optional or not interacting with the second core network function, or to indicate that it is conditional or not interacting with the second core network function;

including transmission type indication information, where the transmission type indication information is used to indicate at least one of following: a transmission type is unicast, and the transmission type is multicast;

including first shared tunnel information; and

first shared tunnel information is absent.

Optionally, the interaction assistance information meets at least one of following:

in a case that the interaction assistance information includes information that is required to be sent to the second core network function, the interaction assistance information is used to indicate that the first core network function is required to interact with the second core network function;

in a case that the interaction assistance information does not include the information that is required to be sent to the second core network function, the interaction assistance information is used to indicate any one of following: the first core network function optionally interacts with or does not interact with the second core network function, and the first core network function conditionally interacts with or does not interact with the second core network function;

in a case that the transmission type indication information included in the interaction assistance information indicates that the transmission type is unicast, the interaction assistance information is used to indicate that the first core network function is required to interact with the second core network function; and

in a case that the transmission type indication information included in the interaction assistance information indicates that the transmission type is multicast, the interaction assistance information is used to indicate any one of following: the first core network function optionally interacts with or does not interact with the second core network function, and the first core network function conditionally interacts with or does not interact with the second core network function.

Optionally, in a case that the interaction assistance information includes the first shared tunnel information, the interaction assistance information is used to indicate that the first core network function is required to interact with the second core network function.

Optionally, in a case that the interaction assistance information does not include the first shared tunnel information, the interaction assistance information is used to indicate any one of following: the first core network function optionally interacts with or does not interact with the second core network function, and the first core network function conditionally interacts with or does not interact with the second core network function.

Optionally, the first shared tunnel information may include at least one of following:

a transmission address and a tunnel identifier.

Optionally, when the interaction assistance information includes the first shared tunnel information, the interaction assistance information may meet at least one of following:

in a case that the first shared tunnel information includes a transmission address, and the transmission address is a multicast address, the interaction assistance information is used to indicate any one of following: the first core network function optionally interacts with or does not interact with the second core network function, and the first core network function conditionally interacts with or does not interact with the second core network function;

in a case that the first shared tunnel information includes a transmission address, and the transmission address is a unicast address or not a multicast address, the interaction assistance information is used to indicate that the first core network function is required to interact with the second core network function;

in a case that the first shared tunnel information includes a tunnel identifier, the interaction assistance information is used to indicate that the first core network function is required to interact with the second core network function; and

in a case that the first shared tunnel information does not include the tunnel identifier, the interaction assistance information is used to indicate any one of following: the first core network function optionally interacts with or does not interact with the second core network function, and the first core network function conditionally interacts with or does not interact with the second core network function.

Optionally, the first shared tunnel information may further include at least one of following:

an MBS session identifier, which is used to indicate a multicast and broadcast session to which the shared tunnel belongs;

MBS QoS flow information, which is used to indicate information or an identifier serving the MBS QoS flow, for example, when the MBS QoS flow changes, the MB-SMF needs to be notified;

MBS service area information, which is used to indicate a multicast and broadcast service area; and

an MBS area session identifier, which is used to uniquely identify one MBS session together with the MBS session identifier in some scenarios.

Optionally, the invoking or rejecting to invoke, based on the interaction assistance information, information related to multicast and broadcast service management or session management to the MB-SMF may include at least one of following:

the first core network function invokes information related to multicast and broadcast service management or session management to the second core network function when the interaction assistance information meets at least one of following: including information that is required to be sent to the second core network function; included first indication information indicates that it is required to interact with the second core network function; included transmission type indication information indicates that the transmission type is unicast; and including shared tunnel information; and

the first core network function invokes or rejects to invoke information related to multicast and broadcast service management or session management to the second core network function when the interaction assistance information meets at least one of following: the information that is required to be sent to the second core network function is absent; included first indication information indicates optionally interacting with or not interacting with the second core network function; included first indication information indicates conditionally interacting with or not interacting with the second core network function; included transmission type indication information indicates that the transmission type is multicast; and shared tunnel information is absent.

Optionally, in this embodiment of this application, the first core network function may invoke or reject to invoke, based on uniqueness of the RAN node when serving a multicast and broadcast service or a session, information related to multicast and broadcast service management or session management to the second core network function.

In some embodiments, when the interaction assistance information indicates that the first core network function optionally interacts with or does not interact with the second core network function, or indicates that the first core network function conditionally interacts with or does not interact with the second core network function, the first core network function may invoke or reject to invoke, based on uniqueness of the RAN node when serving a multicast and broadcast service or a session, information related to multicast and broadcast service management or session management to the second core network function.

Optionally, the invoking or rejecting to invoke, based on uniqueness of the RAN node when serving a multicast service, information related to multicast and broadcast service management or session management to the second core network function may include at least one of following:

when the RAN node is a first RAN node or a last RAN node when serving a multicast and broadcast service or a session, the first core network function invokes information related to multicast and broadcast service management or session management to the second core network function, namely, invoking the service operation of the second core network function; and

when the RAN node is not the first RAN node or the last RAN node when serving a multicast and broadcast service or a session, the first core network function rejects to invoke information related to multicast and broadcast service management or session management to the second core network function, namely, rejecting to invoke the service operation of the second core network function.

It should be noted that the information control method provided in this embodiment of this application can be performed by an information control apparatus or a control module included in the information control apparatus and configured to perform the information control method. In this embodiment of this application, that the information control apparatus performs the information control method is used as an example to describe the information control apparatus provided in the embodiments of this application.

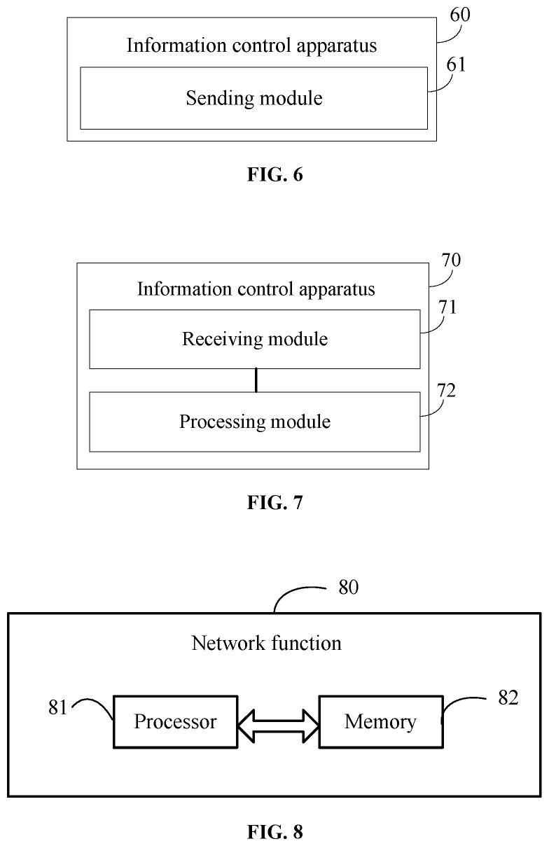

Referring to FIG. 6, FIG. 6 is a schematic diagram of a structure of an information control apparatus according to an embodiment of this application, and the apparatus is applied to the RAN node. As shown in FIG. 6, the information control apparatus 60 includes:

a sending module 61, configured to send interaction assistance information to a first core network function, where

the interaction assistance information is used to assist the first core network function in invoking information related to multicast and broadcast service management or session management to a second core network function, or the interaction assistance information is used to assist the first core network function in rejecting to invoke information related to the multicast and broadcast service management or session management to the second core network function.

Optionally, the interaction assistance information meets at least one of following:

including information that is required to be sent to the second core network function;

the information that is required to be sent to the second core network function is absent;

including first indication information, where the first indication information is used to indicate that it is required to interact with the second core network function; or the first indication information is used to indicate that it is optional or not interacting with the second core network function, or to indicate that it is conditional or not interacting with the second core network function;

including transmission type indication information, where the transmission type indication information is used to indicate at least one of following: a transmission type is unicast, and the transmission type is multicast;

including first shared tunnel information; and

first shared tunnel information is absent.

Optionally, the interaction assistance information meets at least one of following:

in a case that the interaction assistance information includes information that is required to be sent to the second core network function, the interaction assistance information is used to indicate that the first core network function is required to interact with the second core network function;

in a case that the interaction assistance information does not include the information that is required to be sent to the second core network function, the interaction assistance information is used to indicate any one of following: the first core network function optionally interacts with or does not interact with the second core network function, and the first core network function conditionally interacts with or does not interact with the second core network function;

in a case that the transmission type indication information included in the interaction assistance information indicates that the transmission type is unicast, the interaction assistance information is used to indicate that the first core network function is required to interact with the second core network function; and

in a case that the transmission type indication information included in the interaction assistance information indicates that the transmission type is multicast, the interaction assistance information is used to indicate any one of following: the first core network function optionally interacts with or does not interact with the second core network function, and the first core network function conditionally interacts with or does not interact with the second core network function.

Optionally, the first shared tunnel information includes at least one of following:

a transmission address; and

a tunnel identifier.

Optionally, when the interaction assistance information includes the first shared tunnel information, the interaction assistance information meets at least one of following:

in a case that the first shared tunnel information includes a transmission address, and the transmission address is a multicast address, the interaction assistance information is used to indicate any one of following: the first core network function optionally interacts with or does not interact with the second core network function, and the first core network function conditionally interacts with or does not interact with the second core network function;

in a case that the first shared tunnel information includes a transmission address, and the transmission address is a unicast address or not a multicast address, the interaction assistance information is used to indicate that the first core network function is required to interact with the second core network function;

in a case that the first shared tunnel information includes a tunnel identifier, the interaction assistance information is used to indicate that the first core network function is required to interact with the second core network function; and

in a case that the first shared tunnel information does not include the tunnel identifier, the interaction assistance information is used to indicate any one of following: the first core network function optionally interacts with or does not interact with the second core network function, and the first core network function conditionally interacts with or does not interact with the second core network function.

Optionally, the first shared tunnel information further includes at least one of following:

a multicast and broadcast service (MBS) session identifier;

MBS quality of service flow (QoS Flow) information;

MBS service area information; and

an MBS area session identifier.

Optionally, the sending module 61 is further configured to send the interaction assistance information to the first core network function based on second shared tunnel information.

Optionally, when a first condition is met, the interaction assistance information indicates any one of following: the first core network function optionally interacts with or does not interact with the second core network function, and the first core network function conditionally interacts with or does not interact with the second core network function, where

the first condition includes at least one of following:

the second shared tunnel information includes a tunnel identifier; and

the second shared tunnel information includes a transmission address, and the transmission address is a multicast address.

Optionally, when a second condition is met, the interaction assistance information indicates that the first core network function is required to interact with the second core network function, where

the second condition includes at least one of following:

the second shared tunnel information is unknown; and

the second shared tunnel information includes a transmission address, and the transmission address is a unicast address or not a multicast address.

Optionally, the sending module 61 is further configured to send the interaction assistance information to the first core network function through any one of following:

a shared tunnel establishment request, and a shared tunnel release request.

The information control apparatus provided in this embodiment of this application can implement the processes implemented in the method embodiment shown in FIG. 4, and achieve a same technical effect. To avoid repetition, details are not provided herein again.

Referring to FIG. 7, FIG. 7 is a schematic diagram of a structure of another information control apparatus according to an embodiment of this application, and the apparatus is applied to the AMF. As shown in FIG. 7, the information control apparatus 70 includes:

a receiving module 71, configured to receive interaction assistance information from a RAN node; and

a processing module 72, configured to: invoke, based on the interaction assistance information, information related to multicast and broadcast service management or session management to a second core network function, or reject to invoke information related to the multicast and broadcast service management or session management to the second core network function.

Optionally, the interaction assistance information meets at least one of following:

including information that is required to be sent to the second core network function;

the information that is required to be sent to the second core network function is absent;

including first indication information, where the first indication information is used to indicate that it is required to interact with the second core network function; or the first indication information is used to indicate that it is optional or not interacting with the second core network function, or to indicate that it is conditional or not interacting with the second core network function;

including transmission type indication information, where the transmission type indication information is used to indicate at least one of following: a transmission type is unicast, and the transmission type is multicast;

including first shared tunnel information; and

first shared tunnel information is absent.

Optionally, the interaction assistance information meets at least one of following:

in a case that the interaction assistance information includes information that is required to be sent to the second core network function, the interaction assistance information is used to indicate that the first core network function is required to interact with the second core network function;

in a case that the interaction assistance information does not include the information that is required to be sent to the second core network function, the interaction assistance information is used to indicate any one of following: the first core network function optionally interacts with or does not interact with the second core network function, and the first core network function conditionally interacts with or does not interact with the second core network function;

in a case that the transmission type indication information included in the interaction assistance information indicates that the transmission type is unicast, the interaction assistance information is used to indicate that the first core network function is required to interact with the second core network function; and

in a case that the transmission type indication information included in the interaction assistance information indicates that the transmission type is multicast, the interaction assistance information is used to indicate any one of following: the first core network function optionally interacts with or does not interact with the second core network function, and the first core network function conditionally interacts with or does not interact with the second core network function.

Optionally, the first shared tunnel information includes at least one of following:

a transmission address; and

a tunnel identifier.

Optionally, when the interaction assistance information includes the first shared tunnel information, the interaction assistance information meets at least one of following:

in a case that the first shared tunnel information includes a transmission address, and the transmission address is a multicast address, the interaction assistance information is used to indicate any one of following: the first core network function optionally interacts with or does not interact with the second core network function, and the first core network function conditionally interacts with or does not interact with the second core network function;

in a case that the first shared tunnel information includes a transmission address, and the transmission address is a unicast address or not a multicast address, the interaction assistance information is used to indicate that the first core network function is required to interact with the second core network function;

in a case that the first shared tunnel information includes a tunnel identifier, the interaction assistance information is used to indicate that the first core network function is required to interact with the second core network function; and

in a case that the first shared tunnel information does not include the tunnel identifier, the interaction assistance information is used to indicate any one of following: the first core network function optionally interacts with or does not interact with the second core network function, and the first core network function conditionally interacts with or does not interact with the second core network function.

Optionally, when the interaction assistance information indicates that the first core network function optionally interacts with or does not interact with the second core network function, or indicates that the first core network function conditionally interacts with or does not interact with the second core network function, the processing module 72 is further configured for at least one of following:

when the RAN node is a first RAN node or a last RAN node when serving a multicast and broadcast service or a session, invoking information related to multicast and broadcast service management or session management to the second core network function; and

when the RAN node is not the first RAN node or the last RAN node when serving a multicast and broadcast service or a session, rejecting to invoke information related to multicast and broadcast service management or session management to the second core network function.

Optionally, the processing module 72 is further configured to perform at least one of following:

invoking information related to multicast and broadcast service management or session management to the second core network function when the interaction assistance information meets at least one of following: including information that is required to be sent to the second core network function; included first indication information indicates that the first core network function is required to interact with the second core network function; included transmission type indication information indicates that the transmission type is unicast; and including shared tunnel information; and

invoking information related to multicast and broadcast service management or session management to the second core network function, or rejecting to invoke information related to the multicast and broadcast service management or session management to the second core network function when the interaction assistance information meets at least one of following: the information that is required to be sent to the second core network function is absent; included first indication information indicates optionally interacting with or not interacting with the second core network function; included first indication information indicates conditionally interacting with or not interacting with the second core network function; included transmission type indication information indicates that the transmission type is multicast; and shared tunnel information is absent.

Optionally, the processing module 72 is further configured to: invoke, based on uniqueness of the RAN node when serving a multicast and broadcast service or a session, information related to multicast and broadcast service management or session management to the second core network function, or reject to invoke information related to the multicast and broadcast service management or session management to the second core network function.

Optionally, the processing module 72 is further configured to perform at least one of following:

when the RAN node is a first RAN node or a last RAN node when serving a multicast and broadcast service or a session, invoking information related to multicast and broadcast service management or session management to the second core network function; and

when the RAN node is not the first RAN node or the last RAN node when serving a multicast and broadcast service or a session, rejecting to invoke information related to multicast and broadcast service management or session management to the second core network function.

The information control apparatus provided in this embodiment of this application can implement the processes implemented in the method embodiment shown in FIG. 5, and achieve a same technical effect. To avoid repetition, details are not provided herein again.

Optionally, as shown in FIG. 8, an embodiment of this application further provides a network function 80, including a processor 81, a memory 82, and a program or an instruction stored in the memory 82 and executable on the processor 81. For example, in a case that the network function 80 is a RAN node, when the program or the instruction is executed by the processor 81, the processes of the foregoing method embodiments in FIG. 4 are implemented, with the same technical effects achieved. In a case that the network function 80 is an AMF, when the program or the instruction is executed by the processor 81, the processes of the method embodiment shown in FIG. 5 can be implemented, and a same technical effect can be achieved. To avoid repetition, details are not described herein again.

An embodiment of this application further provides a readable storage medium. The readable storage medium may be volatile or non-volatile. The readable storage medium stores a program or an instruction, and the program or the instruction is executed by a processor to implement the processes of the foregoing information control method embodiment, and a same technical effect can be achieved. To avoid repetition, details are not described herein again.

The processor is a processor in the terminal in the foregoing embodiment. The readable storage medium includes a computer-readable storage medium, such as a computer read-only memory (ROM), a random access memory (RAM), a magnetic disk, or an optical disc.

An embodiment of this application further provides a chip. The chip includes a processor and a communications interface, the communications interface is coupled to the processor, and the processor is configured to run a program or an instruction to implement the processes of the embodiment of the information control method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program product. The computer program product is stored in a non-transient storage medium, and the computer program product is executed by at least one processor to implement the processes of the embodiment of the information control method, and a same technical effect can be achieved. To avoid repetition, details are not described herein again.

An embodiment of this application further provides a communications device, configured to perform the processes of the embodiment of the foregoing information control method, and a same technical effect is achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the implementations of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical schemes of this application essentially or the part contributing to the prior art may be implemented in a form of a computer software product. The computer software product is stored in a storage medium (such as a ROM/RAM, a hard disk, or an optical disc), and includes several instructions for instructing a terminal (which may be a mobile phone, a computer, a server, an air conditioner, a network side device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. An information control method, comprising:
sending, by a radio access network (RAN) node, interaction assistance information to a first core network function, wherein
the interaction assistance information is used to assist the first core network function in invoking information related to multicast and broadcast service management or session management to a second core network function, or the interaction assistance information is used to assist the first core network function in rejecting to invoke information related to the multicast and broadcast service management or session management to the second core network function.

2. The method according to claim 1, wherein the interaction assistance information meets at least one of following:
comprising information that is required to be sent to the second core network function;
the information that is required to be sent to the second core network function is absent;
comprising first indication information, wherein the first indication information is used to indicate that it is required to interact with the second core network function; or the first indication information is used to indicate that it is optional or not interacting with the second core network function, or to indicate that it is conditional or not interacting with the second core network function;
comprising transmission type indication information, wherein the transmission type indication information is used to indicate at least one of following: a transmission type is unicast, or the transmission type is multicast;
comprising first shared tunnel information; or
first shared tunnel information is absent.

3. The method according to claim 2, wherein the interaction assistance information meets at least one of following:
in a case that the interaction assistance information comprises information that is required to be sent to the second core network function, the interaction assistance information is used to indicate that the first core network function is required to interact with the second core network function;
in a case that the interaction assistance information does not comprise the information that is required to be sent to the second core network function, the interaction assistance information is used to indicate any one of following: the first core network function optionally interacts with or does not interact with the second core network function, and the first core network function conditionally interacts with or does not interact with the second core network function;
in a case that the transmission type indication information comprised in the interaction assistance information indicates that the transmission type is unicast, the interaction assistance information is used to indicate that the first core network function is required to interact with the second core network function; or
in a case that the transmission type indication information comprised in the interaction assistance information indicates that the transmission type is multicast, the interaction assistance information is used to indicate any one of following: the first core network function optionally interacts with or does not interact with the second core network function, and the first core network function conditionally interacts with or does not interact with the second core network function.

4. The method according to claim 2, wherein the first shared tunnel information comprises at least one of following:
a transmission address; or
a tunnel identifier; or,
wherein the first shared tunnel information comprises at least one of a transmission address or a tunnel identifier, and comprises at least one of following:
a multicast and broadcast service (MBS) session identifier;
MBS quality of service flow information;
MBS service area information; or
an MBS area session identifier.

5. The method according to claim 4, wherein when the interaction assistance information comprises first shared tunnel information, the interaction assistance information meets at least one of following:
in a case that the first shared tunnel information comprises a transmission address, and the transmission address is a multicast address, the interaction assistance information is used to indicate any one of following: the first core network function optionally interacts with or does not interact with the second core network function, and the first core network function conditionally interacts with or does not interact with the second core network function;
in a case that the first shared tunnel information comprises a transmission address, and the transmission address is a unicast address or not a multicast address, the interaction assistance information is used to indicate that the first core network function is required to interact with the second core network function;
in a case that the first shared tunnel information comprises a tunnel identifier, the interaction assistance information is used to indicate that the first core network function is required to interact with the second core network function; or
in a case that the first shared tunnel information does not comprise the tunnel identifier, the interaction assistance information is used to indicate any one of following: the first core network function optionally interacts with or does not interact with the second core network function, and the first core network function conditionally interacts with or does not interact with the second core network function.

6. The method according to claim 1, wherein the sending interaction assistance information to a first core network function comprises:
sending, by the RAN node, the interaction assistance information to the first core network function based on second shared tunnel information;
wherein the interaction assistance information meets at least one of following:
when a first condition is met, the interaction assistance information is used to indicate any one of following: the first core network function optionally interacts with or does not interact with the second core network function, and the first core network function conditionally interacts with or does not interact with the second core network function; or
when a second condition is met, the interaction assistance information is used to indicate that the first core network function is required to interact with the second core network function, wherein
the first condition comprises at least one of following:
the second shared tunnel information comprises a tunnel identifier; or
the second shared tunnel information comprises a transmission address, and the transmission address is a multicast address, wherein
the second condition comprises at least one of following:
the second shared tunnel information is unknown; or
the second shared tunnel information comprises a transmission address, and the transmission address is a unicast address or not a multicast address.

7. The method according to claim 1, wherein the sending interaction assistance information to a first core network function comprises:
sending, by the RAN node, the interaction assistance information to the first core network function through any one of following:
a shared tunnel establishment request, and a shared tunnel release request.

8. An information control method, comprising:
receiving, by a first core network function, interaction assistance information from a RAN node; and
invoking, by the first core network function based on the interaction assistance information, information related to multicast and broadcast service management or session management to a second core network function, or rejecting to invoke information related to the multicast and broadcast service management or session management to the second core network function.

9. The method according to claim 8, wherein the interaction assistance information meets at least one of following:
comprising information that is required to be sent to the second core network function;
the information that is required to be sent to the second core network function is absent;
comprising first indication information, wherein the first indication information is used to indicate that it is required to interact with the second core network function; or the first indication information is used to indicate that it is optional or not interacting with the second core network function, or to indicate that it is conditional or not interacting with the second core network function;
comprising transmission type indication information, wherein the transmission type indication information is used to indicate at least one of following: a transmission type is unicast, and the transmission type is multicast;
comprising first shared tunnel information; or
first shared tunnel information is absent.

10. The method according to claim 9, wherein the interaction assistance information meets at least one of following:
in a case that the interaction assistance information comprises information that is required to be sent to the second core network function, the interaction assistance information is used to indicate that the first core network function is required to interact with the second core network function;
in a case that the interaction assistance information does not comprise the information that is required to be sent to the second core network function, the interaction assistance information is used to indicate any one of following: the first core network function optionally interacts with or does not interact with the second core network function, and the first core network function conditionally interacts with or does not interact with the second core network function;
in a case that the transmission type indication information comprised in the interaction assistance information indicates that the transmission type is unicast, the interaction assistance information is used to indicate that the first core network function is required to interact with the second core network function; or
in a case that the transmission type indication information comprised in the interaction assistance information indicates that the transmission type is multicast, the interaction assistance information is used to indicate any one of following: the first core network function optionally interacts with or does not interact with the second core network function, and the first core network function conditionally interacts with or does not interact with the second core network function.

11. The method according to claim 9, wherein the first shared tunnel information comprises at least one of following:
a transmission address; or
a tunnel identifier; or,
the first shared tunnel information comprises at least one of a transmission address and a tunnel identifier, and comprises at least one of following:
a multicast and broadcast service (MBS) session identifier;
MBS quality of service flow information;
MBS service area information; or
an MBS area session identifier.

12. The method according to claim 11, wherein when the interaction assistance information comprises first shared tunnel information, the interaction assistance information meets at least one of following:
in a case that the first shared tunnel information comprises a transmission address, and the transmission address is a multicast address, the interaction assistance information is used to indicate any one of following: the first core network function optionally interacts with or does not interact with the second core network function, and the first core network function conditionally interacts with or does not interact with the second core network function;
in a case that the first shared tunnel information comprises a transmission address, and the transmission address is a unicast address or not a multicast address, the interaction assistance information is used to indicate that the first core network function is required to interact with the second core network function;
in a case that the first shared tunnel information comprises a tunnel identifier, the interaction assistance information is used to indicate that the first core network function is required to interact with the second core network function; or
in a case that the first shared tunnel information does not comprise the tunnel identifier, the interaction assistance information is used to indicate any one of following: the first core network function optionally interacts with or does not interact with the second core network function, and the first core network function conditionally interacts with or does not interact with the second core network function.

13. The method according to claim 9, wherein when the interaction assistance information indicates that the first core network function optionally interacts with or does not interact with the second core network function, or indicates that the first core network function conditionally interacts with or does not interact with the second core network function, the method further comprises at least one of following:
when the RAN node is a first RAN node or a last RAN node when serving a multicast and broadcast service or a session, the first core network function invokes information related to multicast and broadcast service management or session management to the second core network function; or
when the RAN node is not the first RAN node or the last RAN node when serving a multicast and broadcast service or a session, the first core network function rejects to invoke information related to multicast and broadcast service management or session management to the second core network function.

14. The method according to claim 9, wherein the invoking, based on the interaction assistance information, information related to multicast and broadcast service management or session management to a second core network function, or rejecting to invoke information related to the multicast and broadcast service management or session management to the second core network function comprises at least one of following:
the first core network function invokes information related to multicast and broadcast service management or session management to the second core network function when the interaction assistance information meets at least one of following: comprising information that is required to be sent to the second core network function; comprised first indication information indicates that the first core network function is required to interact with the second core network function; comprised transmission type indication information indicates that the transmission type is unicast; or comprising shared tunnel information; or
the first core network function invokes information related to multicast and broadcast service management or session management to the second core network function, or rejects to invoke information related to the multicast and broadcast service management or session management to the second core network function when the interaction assistance information meets at least one of following: the information that is required to be sent to the second core network function is absent; comprised first indication information indicates optionally interacting with or not interacting with the second core network function; comprised first indication information indicates conditionally interacting with or not interacting with the second core network function; comprised transmission type indication information indicates that the transmission type is multicast; or shared tunnel information is absent.

15. The method according to claim 8, wherein the method further comprises:
invoking, by the first core network function based on uniqueness of the RAN node when serving a multicast and broadcast service or a session, information related to multicast and broadcast service management or session management to the second core network function, or rejecting to invoke information related to the multicast and broadcast service management or session management to the second core network function;
wherein the invoking, based on uniqueness of the RAN node when serving a multicast and broadcast service or a session, information related to multicast and broadcast service management or session management to the second core network function, or rejecting to invoke information related to the multicast and broadcast service management or session management to the second core network function comprises at least one of following:
when the RAN node is a first RAN node or a last RAN node when serving a multicast and broadcast service, the first core network function invokes information related to multicast and broadcast service management or session management to the second core network function; or
when the RAN node is not the first RAN node or the last RAN node when serving a multicast and broadcast service, the first core network function rejects to invoke information related to multicast and broadcast service management or session management to the second core network function.

16. A network node, comprising a processor, a memory, and a program or an instruction stored in the memory and executable on the processor, wherein the program or the instruction, when executed by the processor, causes the network node to perform:
sending interaction assistance information to a first core network function, wherein
the interaction assistance information is used to assist the first core network function in invoking information related to multicast and broadcast service management or session management to a second core network function, or the interaction assistance information is used to assist the first core network function in rejecting to invoke information related to the multicast and broadcast service management or session management to the second core network function.

17. The network node according to claim 16, wherein the interaction assistance information meets at least one of following:
comprising information that is required to be sent to the second core network function;
the information that is required to be sent to the second core network function is absent;
comprising first indication information, wherein the first indication information is used to indicate that it is required to interact with the second core network function; or the first indication information is used to indicate that it is optional or not interacting with the second core network function, or to indicate that it is conditional or not interacting with the second core network function;
comprising transmission type indication information, wherein the transmission type indication information is used to indicate at least one of following: a transmission type is unicast, or the transmission type is multicast;
comprising first shared tunnel information; or
first shared tunnel information is absent.

18. The network node according to claim 17, wherein the interaction assistance information meets at least one of following:
in a case that the interaction assistance information comprises information that is required to be sent to the second core network function, the interaction assistance information is used to indicate that the first core network function is required to interact with the second core network function;
in a case that the interaction assistance information does not comprise the information that is required to be sent to the second core network function, the interaction assistance information is used to indicate any one of following: the first core network function optionally interacts with or does not interact with the second core network function, and the first core network function conditionally interacts with or does not interact with the second core network function;
in a case that the transmission type indication information comprised in the interaction assistance information indicates that the transmission type is unicast, the interaction assistance information is used to indicate that the first core network function is required to interact with the second core network function; or
in a case that the transmission type indication information comprised in the interaction assistance information indicates that the transmission type is multicast, the interaction assistance information is used to indicate any one of following: the first core network function optionally interacts with or does not interact with the second core network function, and the first core network function conditionally interacts with or does not interact with the second core network function.

19. The network node according to claim 16, wherein when sending interaction assistance information to a first core network function, the program or the instruction, when executed by the processor, causes the network node to perform:
sending the interaction assistance information to the first core network function through any one of following:
a shared tunnel establishment request, and a shared tunnel release request.

20. A network element, comprising a processor, a memory, and a program or an instruction stored in the memory and executable on the processor, wherein when the program or the instruction is executed by the processor, steps of the information control method according to claim 8 are implemented.
